(19) United States
(12) Patent Application Publication
(10) Pub. No.: US 2024/0031999 A1
(43) Pub. Date: Jan. 25, 2024

(54) Method and Apparatus of Partial Sensing for Resource Selection in Sidelink Communications

(71) Applicant: Huawei Technologies Co., Ltd., Shenzhen (CN)

(72) Inventors: Guosen Yue, Edison, NJ (US); Brian Classon, St. Pete Beach, FL (US); Vipul Anilkumar Desai, Palatine, IL (US); Weimin Xiao, Hoffman Estates, IL (US)

(21) Appl. No.: 18/479,299

(22) Filed: Oct. 2, 2023

Related U.S. Application Data
(63) Continuation of application No. PCT/US2022/023341, filed on Apr. 4, 2022.
(60) Provisional application No. 63/275,807, filed on Nov. 4, 2021.
(60) Provisional application No. 63/171,006, filed on Apr. 5, 2021.

(51) Int. Cl. H04W 72/02; H04W 72/0446

(52) U.S. Cl. CPC H04W 72/02; H04W 72/0446

(57) ABSTRACT

A system and method for operating a user equipment (UE) for sidelink transmission of data in a wireless communications system includes the UE determining a candidate resource region for a transmission of data, the candidate resource region indicating candidate resource slots for the transmission of the data, monitoring sensing slots in sensing occasions to determine available resources from the candidate resource region, the sensing occasions being determined in accordance with the candidate resource region, a periodicity for sensing, and a maximum number of the sensing occasions, selecting, by the UE, a resource from the available resources, and transmitting, by the UE, data over the selected resource.

### CROSS-REFERENCE TO RELATED APPLICATIONS

This patent application is continuation of International Patent Application No. PCT/US2022/023341, filed on Apr. 4, 2022 and entitled “Method and Apparatus of Partial Sensing for Resource Selection in Sidelink Communications,” which claims priority to U.S. Provisional Application No. 63/171,006, filed on Apr. 5, 2021 and entitled “Method and Apparatus of Partial Sensing for Resource Selection in Sidelink Communications” and U.S. Provisional Application No. 63/275,807, filed on Nov. 4, 2021 and entitled “Method and Apparatus of Partial Sensing and Inter-UE Coordination for Resource Selection in Sidelink Communications,” applications of which are hereby incorporated by reference herein as if reproduced in their entirety.

### TECHNICAL FIELD

The present disclosure relates generally to managing the allocation of resources in a network, and in particular embodiments, to techniques and mechanisms for sidelink communications.

### BACKGROUND

The third generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provided the basics of NR sidelink communication for applications such as safety systems and autonomous driving. High data rates, low latencies, and high reliabilities are some of the key areas that are being investigated and standardized. In Release-17, a work item of Sidelink Enhancement was approved to further enhance the capabilities and performance of sidelink communication. One of the important objectives of the work item is to introduce UE coordination mechanism where the UE shares resource for the other UEs to use in their resource selection.

### SUMMARY

In accordance with an embodiment, a method implemented by a user equipment (UE) is provided. The method comprises the UE determining a candidate resource region for a transmission of data, the candidate resource region indicating candidate resource slots for the transmission of the data, sensing using sensing occasions to determine available resources from the candidate resource region, the sensing occasions being determined in accordance with the candidate resource region, a periodicity for sensing, and a maximum number of the sensing occasions selecting a resource from the available resources, and transmitting the data over the selected resource.

In accordance with another embodiment, a method implemented by a user equipment (UE) is provided. The method comprises the UE determining a candidate resource region for transmission of data, the candidate resource region indicating candidate resource slots for the transmission of the data, monitoring sensing slots within a slot window to determine available resources from the candidate resource slots, wherein a first slot of the sensing slots is determined in accordance with a first slot of the candidate resource slots, selecting a resource from the available resources, and transmitting the data over the resource selected from the available resources.

Optionally, in any of the preceding aspects, the transmission of the data is a periodic transmission.

Optionally, in any of the preceding aspects, the first slot of the sensing slots is further determined in accordance with a default number of slots.

Optionally, in any of the preceding aspects, the default number of slots is 31.

Optionally, in any of the preceding aspects, the first slot of the sensing slots is further determined in accordance with a preconfigured number of slots, the preconfigured number of slots being smaller than the default number of slots.

Optionally, in any of the preceding aspects, the first slot of the sensing slots is earlier than the first slot of candidate resource region by the default number of slots.

Optionally, in any of the preceding aspects, the first slot of the sensing slots is earlier than the first slot of the candidate resource slots by the preconfigured number of slots.

Optionally, in any of the preceding aspects, the transmission of the data is an aperiodic transmission.

Optionally, in any of the preceding aspects, the first slot of the sensing slots is further determined in accordance with a minimum number of sensing slots, the minimum number of sensing slots being a default value.

Optionally, in any of the preceding aspects, the first slot of the sensing slots is earlier than the first slot of the candidate resource slots by at least the minimum number of sensing slots.

Optionally, in any of the preceding aspects, the default value is 31.

Optionally, in any of the preceding aspects, the first slot of the sensing slots is earlier than the first slot of the candidate resource slots by at least a minimum number of sensing slots, the minimum number of sensing slots being a preconfigured value from a range of values.

In accordance with yet another embodiment, a method implemented by a user equipment (UE) is provided. The method comprises the UE determining a candidate resource region for transmission of data, the candidate resource region indicating candidate resource slots for the transmission of the data, monitoring sensing slots to determine available resources from the candidate resource region, wherein the sensing is in accordance with the candidate resource region and a sensing window size, comparing a ratio of the available resources to a threshold, wherein the threshold is a function of the sensing window size, selecting a resource from the available resources responsive to the ratio being larger than the threshold, and transmitting the data over the selected resource.

Optionally, in any of the preceding aspects, the method implemented by a UE further comprises increasing the sensing window size responsive to the ratio being less than the threshold.

Optionally, in any of the preceding aspects, the method implemented by a UE further comprises increasing the threshold responsive to the increased sensing window size.

Optionally, in any of the preceding aspects, the selecting comprises the UE selecting multiple candidate resources in accordance with a difference between a first slot of a first reserved resource and a second slot of a second reserved resource being smaller than a value.

Optionally, in any of the preceding aspects, the ratio is determined in accordance with a number of available resources and a total number of candidate resources.

In accordance with yet another embodiment, a method implemented by a user equipment (UE) is provided. The method comprises the UE determining a candidate resource region for periodic transmission of data, the candidate resource region indicating candidate resource slots for the periodic transmission of the data, sensing using sensing slots to determine available resources from the candidate resource region, wherein the sensing is in accordance with the candidate resource region and a sensing window size, calculating a channel busy ratio in accordance with the sensing within a channel busy ratio measurement window, and selecting a resource selection method in accordance with the channel busy ratio and a threshold, wherein the resource selection method is one of sensing selection or random selection.

Optionally, in any of the preceding aspects, the channel busy ratio is a ratio of sub-channels whose sidelink signal strength measured by the UE exceeds a second threshold on a signal strength sensed over the channel busy ratio measurement window.

Optionally, in any of the preceding aspects, the method implemented by a UE further comprises selecting a resource from the candidate resource region, wherein the selection comprises randomly selecting the resource for a specified time, responsive to the UE determining that the resource selection method is the random selection.

Optionally, in any of the preceding aspects, the specified time for the random selection is a fixed value.

Optionally, in any of the preceding aspects, the specified time for the random selection is a random value within a range.

In accordance with yet another embodiment, a method implemented by a user equipment (UE) is provided. The method comprises the UE sensing using sensing slots having a first sensing window size for a first candidate resource region, the first candidate resource region comprising candidate resources for transmission of data by a second UE, determining a set of preferred resources or non-preferred resources in the first candidate resource region for the transmission of the data by the second UE, selecting a resource from a second candidate resource region having a second sensing window size, the second candidate resource region containing second candidate resources for transmission of the set of preferred resources or non-preferred resources to the second UE, wherein a last slot of the second candidate resource region is determined in accordance with the first candidate resource region, and transmitting to the second UE, the set of preferred resources or non-preferred resources for the transmission of the second UE over the selected resource.

Optionally, in any of the preceding aspects, the last slot of the second candidate resource region is earlier than a first slot of the first candidate resource region by a number of slots determined by subcarrier spacing.

Optionally, in any of the preceding aspects, the last slot of the second candidate resource region is earlier than a first slot of the first candidate resource region by a processing time for resource selection.

Optionally, in any of the preceding aspects, the last slot of the second candidate resource region is earlier than a first slot of the first candidate resource region by a processing time for processing sensing and resource selection.

Optionally, in any of the preceding aspects, the second sensing window size is in accordance with a first slot of the first candidate resource region.

Optionally, in any of the preceding aspects, the last slot of the second sensing window is earlier than the first slot of the first candidate resource region by a processing time for processing sensing and resource selection.

In accordance with yet another embodiment, a user equipment (UE) is provided. The UE comprises a non-transitory memory storage comprising instructions and one or more processors in communication with the memory storage, the one or more processors executing the instructions to determine a candidate resource region for a transmission of data, the candidate resource region indicating candidate resource slots for the transmission of the data, sense using sensing occasions to determine available resources from the candidate resource region, the sensing occasions being determined in accordance with the candidate resource region, a periodicity for sensing, and a maximum number of sensing occasions, select a resource from the available resources, and transmit the data over the selected resource.

In accordance with yet another embodiment, a user equipment (UE) is provided. The UE comprises a non-transitory memory storage comprising instructions and one or more processors in communication with the memory storage, the one or more processors executing the instructions to determine a candidate resource region for transmission of data, the candidate resource region indicating candidate resource slots for the transmission of the data, sense using sensing slots within a slot window to determine available resources from the candidate resource region, wherein a first slot of the sensing slots is determined in accordance with a first slot of the candidate resource slots, select a resource from the available resources, and transmit the data over the resource selected from the available resources.

Optionally, in any of the preceding aspects, the transmission of the data is a periodic transmission.

Optionally, in any of the preceding aspects, the first slot of the sensing slots is further determined in accordance with a default number of slots.

Optionally, in any of the preceding aspects, the default number of slots is 31.

Optionally, in any of the preceding aspects, the first slot of the sensing slots is further determined in accordance with a preconfigured number of slots, the preconfigured number of slots being smaller than the default number of slots.

Optionally, in any of the preceding aspects, the first slot of the sensing slots is earlier than the first slot of candidate resource region by the default number of slots.

Optionally, in any of the preceding aspects, the first slot of the sensing slots is earlier than the first slot of the candidate resource slots by the preconfigured number of slots.

Optionally, in any of the preceding aspects, the transmission of the data is an aperiodic transmission.

Optionally, in any of the preceding aspects, the first slot of the sensing slots is further determined in accordance with a minimum number of sensing slots, the minimum number of sensing slots being a default value.

Optionally, in any of the preceding aspects, the first slot of the sensing slots is earlier than the first slot of the candidate resource slots by at least the minimum number of sensing slots.

Optionally, in any of the preceding aspects, the default value is 31.

Optionally, in any of the preceding aspects, the first slot of the sensing slots is earlier than the first slot of the candidate resource slots by at least a minimum number of sensing slots, the minimum number of sensing slots being a preconfigured value from a range of values.

In accordance with yet another embodiment, a user equipment (UE) is provided. The UE comprises a non-transitory memory storage comprising instructions and one or more processors in communication with the memory storage, the one or more processors executing the instructions to determine a candidate resource region for transmission of data, the candidate resource region indicating candidate resource slots for the transmission of the data, sense using sensing slots to determine available resources from the candidate resource region, wherein the sensing is in accordance with the candidate resource region and a sensing window size; compare a ratio of the available resources to a threshold, wherein the threshold is a function of the sensing window size, select a resource from the available resources responsive to the ratio being larger than the threshold, and transmit the data over the selected resource.

Optionally, in any of the preceding aspects, the one or more processors further execute the instructions to increase the sensing window size responsive to the ratio being less than the threshold.

Optionally, in any of the preceding aspects, the one or more processors further execute the instructions to increase the threshold responsive to the increased sensing window size.

Optionally, in any of the preceding aspects, the selecting of the resource comprises the UE selecting multiple candidate resources in accordance with a difference between a first slot of a first reserved resource and a second slot of a second reserved resource being smaller than a value.

Optionally, in any of the preceding aspects, the ratio is determined in accordance with a number of available resources and a total number of candidate resources.

In accordance with yet another embodiment, a user equipment (UE) is provided. The UE comprises a non-transitory memory storage comprising instructions and one or more processors in communication with the memory storage, the one or more processors executing the instructions to determine a candidate resource region for periodic transmission of data, the candidate resource region indicating candidate resource slots for the periodic transmission of the data, sense using sensing slots to determine available resources from the candidate resource region, wherein the sensing is in accordance with the candidate resource region and a sensing window size, calculate a channel busy ratio in accordance with the sensing within a channel busy ratio measurement window, and select a resource selection method in accordance with the channel busy ratio and a threshold, wherein the resource selection method is one of sensing selection or random selection.

Optionally, in any of the preceding aspects, the channel busy ratio is a ratio of sub-channels whose sidelink signal strength measured by the UE exceeds a second threshold on a signal strength sensed over the channel busy ratio measurement window.

Optionally, in any of the preceding aspects, the one or more processors further execute the instructions to select a resource from the candidate resource region, wherein the resource selection method comprises randomly selecting the resource for a specified time, responsive to the UE determining that the resource selection method is the random selection.

Optionally, in any of the preceding aspects, the specified time for the random selection is a fixed value.

Optionally, in any of the preceding aspects, the specified time for the random selection is a random value within a range.

In accordance with yet another embodiment, a user equipment (UE) is provided. The UE comprises a non-transitory memory storage comprising instructions and one or more processors in communication with the memory storage, the one or more processors executing the instructions to sense using sensing slots having a first sensing window size for a first candidate resource region, the first candidate resource region comprising candidate resources for transmission of data by a second UE, determine a set of preferred resources or non-preferred resources in the first candidate resource region for the transmission of the data by the second UE, select a resource from a second candidate resource region having a second sensing window size, the second candidate resource region containing candidate resources for transmission of the set of preferred resources or non-preferred resources to the second UE, wherein a last slot of the second candidate resource region is determined in accordance with the first candidate resource region, and transmit, to the second UE, the set of preferred resources or non-preferred resources for the transmission of the second UE over the selected resource.

Optionally, in any of the preceding aspects, the last slot of the second candidate resource region is earlier than a first slot of the first candidate resource region by a number of slots determined by subcarrier spacing.

Optionally, in any of the preceding aspects, the last slot of the second candidate resource region is earlier than a first slot of the first candidate resource region by a processing time for resource selection.

Optionally, in any of the preceding aspects, the last slot of the second candidate resource region is earlier than a first slot of the first candidate resource region by a processing time for processing sensing and resource selection.

Optionally, in any of the preceding aspects, the second sensing window size is in accordance with a first slot of the first candidate resource region.

Optionally, in any of the preceding aspects, the last slot of the second sensing window is earlier than the first slot of the first candidate resource region by a processing time for processing sensing and resource selection.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless communications network;

FIG. 2 illustrates a diagram of in-coverage/out-of-coverage operation;

FIG. 3 illustrates a diagram of a resource pool in a resource grid;

FIG. 4 illustrates a diagram of a sub-channel with PSCCH, PSSCH and PSFCH resources;

FIG. 5 illustrates a diagram of sensing and resource selection windows of Rel-16 NR V2X sidelink mode 2;

FIG. 6A illustrates a diagram of full sensing in Rel-16 NR Sidelink;

FIG. 6B illustrates a diagram of partial sensing, according to example embodiments disclosed herein;

FIG. 7 illustrates a diagram of progressive sensing, according to example embodiments disclosed herein;

FIG. 8 illustrates a diagram of switching between sensing based and random resource selection, according to example embodiments disclosed herein;

FIG. 9A illustrates a flowchart of switching between sensing based resource selection and random resource selection, according to example embodiments disclosed herein;

FIG. 9B illustrates a flowchart of switching between sensing based resource selection and random resource selection with protection, according to example embodiments disclosed herein;

FIG. 10 illustrates a diagram of periodic based partial sensing, according to example embodiments disclosed herein;

FIG. 11 illustrates a diagram of timing for contiguous based partial sensing for SL transmissions with periodic traffic, according to example embodiments disclosed herein;

FIG. 12 illustrates a diagram of effective range on the slots in the resource select window, according to example embodiments disclosed herein;

FIG. 13 illustrates a diagram of timing for contiguous based partial sensing for SL transmissions with aperiodic traffic, according to example embodiments disclosed herein;

FIG. 14 illustrates a diagram of timing for UE B sensing and sending coordination message for periodic traffic at UE, according to example embodiments disclosed herein;

FIG. 15 illustrates a diagram of timing for UE B sensing and sending coordination message for aperiodic traffic at UE, according to example embodiments disclosed herein;

FIG. 16 illustrates a diagram of an embodiment processing system; and

FIG. 17 illustrates a diagram of an embodiment transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific example embodiments discussed herein are merely illustrative and do not serve to limit the scope of the claims. Further, it should be understood that various changes, substitutions and alterations can be made herein without departing from the spirit and scope of this disclosure as defined by the appended claims. While the inventive aspects are described primarily in the context of 5G wireless networks, it should also be appreciated that those inventive aspects may also be applicable to 4G and 3G wireless networks.

Several embodiments to reduce sidelink power consumption are disclosed herein. While these embodiments are applicable for all UEs, they are especially applicable for UEs supporting sidelink functionality.

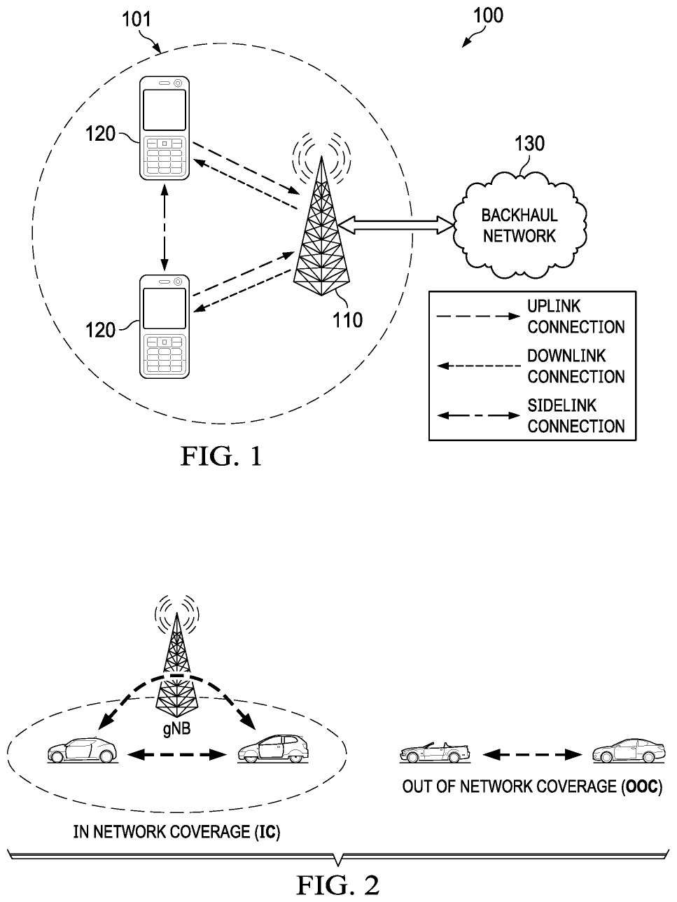

FIG. 1 illustrates a network 100 for communicating data. The network 100 comprises a base station 110 having a coverage area 101, a plurality of mobile devices 120, and a backhaul network 130. As shown, the base station 110 establishes uplink (dashed line) and/or downlink (dotted line) connections with the mobile devices 120, which serve to carry data from the mobile devices 120 to the base station 110 and vice-versa. Data carried over the uplink/downlink connections may include data communicated between the mobile devices 120, as well as data communicated to/from a remote-end (not shown) byway of the backhaul network 130. A sidelink connection between mobile device 120 and mobile device 120 also is shown. As discussed above, the sidelink connection provides a capability for mobile devices 120 and 120 to communicate directly with one another. As used herein, the term “base station” refers to any component (or collection of components) configured to provide wireless access to a network, such as an enhanced base station (eNB), a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a user equipment (UE), a mobile station (STA), and other wirelessly enabled devices. In some embodiments, the network 100 may comprise various other wireless devices, such as relays, low power nodes, etc.

In Release-17, a work item of Sidelink Enhancement was approved to further enhance the capabilities and performance of sidelink communication. One of the important objectives of the work item is to introduce UE coordination mechanism where the UE shares information on resources for the other UEs to use in their resource selection.

FIG. 2 illustrates the communication being either in-coverage, or out-of-coverage: with in-coverage (IC) operation, a central node (eNB, gNB) is present and can be used to manage the sidelink. With out-of-coverage (OOC) operation, the system operation is fully distributed, and UEs select resources on their own. A mode 1 NR UE transmits and receives information under network management while a mode 2 NR UE transmits and receives information without network management. In this disclosure, some UEs could also be facilitated/assisted in selecting their resources.

For the purpose of sidelink communications, the notion of resource pools was introduced for the LTE sidelink and is being reused for NR sidelink. A resource pool is a set of resources that can be used for sidelink communication. Resources in a resource pool are configured for different channels including control channels, shared channels, feedback channels, synchronization signals, reference signals, broadcast channels (e.g., master information block), and so on. The standard defines rules on how the resources are shared and used for a particular configuration of the resource pool.

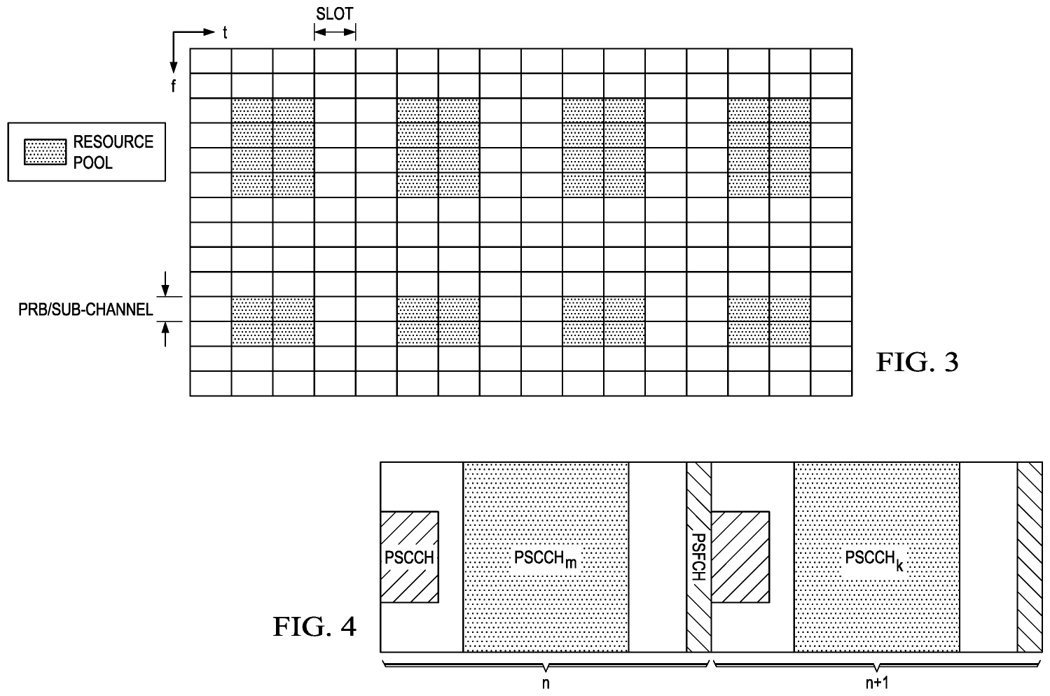

FIG. 3 illustrates an example of a resource pool in the time-frequency resource grid. A resource pool for sidelink can be configured in units of slots in the time domain and physical resource blocks (PRBs) or sub-channels in the frequency domain. A sub-channel consists of one or more PRBs.

For NR mobile broadband (MBB), each physical resource block (PRB) in the grid is defined as a slot of 14 consecutive OFDM symbols in the time domain and 12 consecutive subcarriers in the frequency domain, i.e., each resource block contains 12×14 resource elements (REs). (When used as a frequency-domain unit, a PRB is 12 consecutive subcarriers.) There are 14 symbols in a slot when a normal cyclic prefix is used and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. Each PRB may be allocated to combinations of a control channel, a shared channel, a feedback channel, reference signals, and so on. In addition, some REs of a PRB may be reserved. A similar structure is used on the sidelink as well. A communication resource may be a PRB, a set of PRBs, a code (if CDMA is used, similarly as for the PUCCH), a physical sequence, a set of REs, and so on.

FIG. 4 illustrates an example sub-channel used for communications. The physical sidelink control channel (PSCCH) carries the sidelink control information (SCI). The source UE uses the SCI to schedule the transmission of data on the physical sidelink shared channel (PSSCH). The SCI can convey the time and frequency resources of the PSSCH, parameters for hybrid automatic repeat request (HARQ) process, such as the redundancy version, process id, new data indicator, and resources for the physical sidelink feedback channel (PFSCH). The PFSCH can carry an indication (HARQ-ACK) of whether the recipient [destination] UE decoded the payload carried on PSSCH correctly (e.g., an acknowledgement or negative acknowledgement (ACK/NACK). The SCI can also carry a bit field indicating a representation who the source UE is. In addition, the SCI can also carry a bit field indicating a representation who the destination UE(s) is/are. Other fields include the modulation coding scheme used to encode the payload and modulate the coded payload bits; the demodulation reference signal (DMRS) pattern, the antenna ports, and priority of the payload (transmission).

In Release-16, 3GPP introduced NR sidelink communication between devices such as user equipment (UE) in addition to the typical Downlink and Uplink transmission. In sidelink-communication capable devices, the UEs would regularly exchange control/data information to other UEs.

In Rel-17 sidelink enhancements specify resource allocation to reduce power consumption of the UEs. The baseline is to introduce the principle of Rel-14 LTE sidelink random resource selection and partial sensing to the Rel-16 NR sidelink resource allocation mode. Taking Rel-14 as the baseline does not preclude introducing a new solution to reduce power consumption for the cases where the baseline cannot work properly.

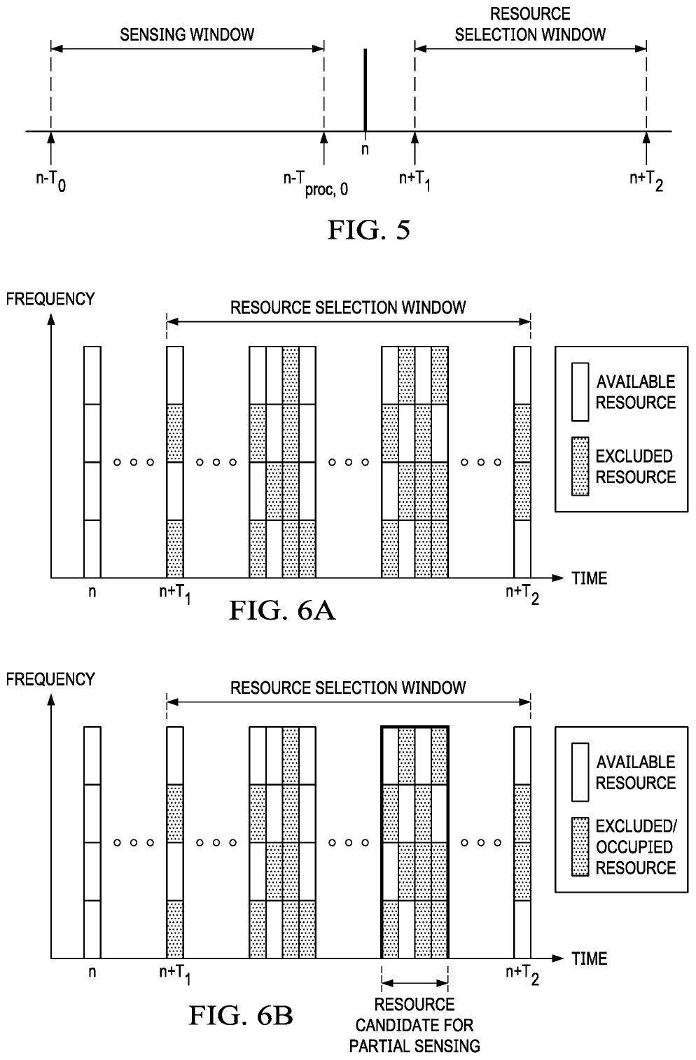

In Rel-16 NR V2X sidelink, mode 2 UEs transmit and receive information without network management. UEs themselves allocate the resources from a resource pool for sidelink transmissions. The resource allocation relies on a sensing and reservation process as shown in FIG. 5. During the sensing procedure, a monitoring UE detects SCI transmitted in each slot in the sensing window and measures reference signal received power (RSRP) of the resource indicated in the SCI. A monitoring UE may also receive transmissions of data (also be a receiving UE) while sensing. For periodic traffic, the resource reservations for sidelink transmissions, if a UE, e.g., UE m, occupies a resource on slot sm, it will also occupy the resource on slot sm+q*RRIm where q is an integer, RRIm is resource reservation interval for UE m that the sensing UE detected. Detecting includes the steps of receiving and decoding the PSCCH and processing the SCI within the PSCCH.

For aperiodic or dynamic transmissions, the transmitting UE reserves multiple resources and indicates the next resource in the SCI. Therefore, based on the sensing results, a monitoring UE can determine which resources may be occupied in the future and can avoid them for its own transmission if the measured RSRP on the occupied resource is larger than a RSRP threshold during the sensing period.

FIG. 5 illustrates the timing information on the sensing and resource selection for Rel-16 NR sidelink transmission, which is usually referred as full sensing. When resource selection is triggered on slot n, based on sensing results in the sensing window, i.e., on slots [n−T₀, n−T_{proc,0}], the transmitting UE selects the resources in the resource selection window, i.e., on slots [n+T₁, n+T₂], where
T₀: number of slots with the value determined by resource pool configuration;
T_{proc,0}: time required for a UE to complete the sensing process;
T₁: processing time required for identification of candidate resources and resource selection T₁≤T_{proc,1};
T₂: the last slot of resource pool for resource selection which is left to UE implementation but in the range of [T₂ₘᵢₙ,PDB] where T₂ₘᵢₙ is minimum value of T₂ and PDB denotes packet delay budget, the remaining time for UE transmitting the data packet;
T_{proc,1}: maximum time required for a UE to identify candidate resources and select new sidelink resources.

To select a resource, the transmitting UE needs to identify the candidate resources by excluding the occupied resources with measured RSRP over a configured RSRP threshold. Then the transmitting UE compares the ratio of the available resources over all resources in the selection window. If the available resource ratio is greater than a threshold X %, then UE selects a resource randomly among the candidate resources. If the ratio is smaller, the transmitting UE then increases the RSRP threshold by 3 dB and checks the available resource ratio until the available resource ratio is equal to or greater than X %. X is chosen from a list, sl-TxPercentageList, and its value is determined by data priority, as specified in TS38.214:
sl-TxPercentageList: internal parameter X for a given prio_TX is defined as sl-TxPercentageList (prio_TX) converted from percentage to a ratio.

The possible values of X in sl-TxPercentageList are 20, 35, and 50 (which correspond to 20%, 35%, and 50%, respectively), as specified in TS38.331 below:

| | |
|---|---|
| SL-TxPercentageList-r16 ::= | SEQUENCE (SIZE (8)) OF SL |
| TxPercentageConfig-r16 | |
| SL-TxPercentageConfig-r16 ::= | SEQUENCE { |
| sl-Priority-r16 | INTEGER (1..8), |
| sl-TxPercentage-r16 | ENUMERATED {p20, p35, p50} |

When a monitoring UE performs sensing, it decodes the SCI on the PSCCH on every resource and every slot in the sensing window when it is not transmitting. The monitoring UE also needs to measure the RSRP on the PSSCH for every identified resource allocation. This process causes large power consumption. To reduce power consumption, sensing with a smaller window size, i.e., partial sensing, is desired. Some issues of partial sensing are identified. The general concepts and solutions are provided, along with detailed specifications for various cases.

As shown in FIG. 6A, the resources in the resource selection window form a large resource pool. With full sensing, in the sensing window on slots [n−T0, n−Tproc,0], the transmitting UE is able to detect occupied slots over a large time range and derive possible resource conflicts for periodic transmissions in the resource selection window. Due to the large resource pool in the resource selection window and the long sensing period, the candidate resource set formed from the sensing results is reliable. With the candidate resource ratio greater than X % for a certain X value, there is relatively a large number of resources for the transmitting UE to select so that potential conflicts with 1) undetected transmissions from some UEs for periodic (new or old) and aperiodic traffic and 2) the new resource selection from other UEs are small.

However, for partial sensing as shown in FIG. 6B, with periodic transmission as an example, the resource selection is from a smaller selection window of Y slots, and the transmitting UE derives the available candidate resources based on the sensing results of a smaller sensing window. Due to a smaller sensing window and SL transmissions with different periodicities, the detection of available candidate resources for resource selection is less reliable. Also due to smaller resource selection window, with the same available resource ratio, the number of available resources is much less. Therefore, the potential resource conflicts due to the above two scenarios are much higher than with full sensing.

Therefore, for partial sensing having different available thresholds on the available resource ratio is beneficial. In general, the threshold X % should increase for partial sensing with smaller sensing window and/or smaller resource selection pool. And the threshold can be a function of or determined by Y, the size of the resource selection, where the sensing results are accounted for resource reservation. The specification of X % for partial sensing can be one of the following:
1. A new list of X %, e.g., sl-TxPercentagePartialSensingList, can be specified for partial sensing,
2. One or more offset values on the existing list, sl-TxPercentageList, in NR release 16, e.g. (Xᵢ+ΔX) %, or (Xᵢ+ΔXᵢ)%, for partial sensing,
3. As a special case, for partial sensing, choose the next in the list sl-TxPercentageList for a range of Y, i.e., given that Xᵢ is obtained from sl-TxPercentageList (prio_{TX}), select Xᵢ₊₁ in the list sl-TxPercentageList if Xᵢ₊₁ is available,
4. Restriction of X in the list for partial sensing with some conditions, e.g., very small Y, continuous partial sensing with small sensing size,
5. X is a function of data priority and Y, i.e., X(prio_{Tx}, Y) for partial sensing. For example, specify the range of Y for the threshold Xᵢ %, Y_{th,i}≤Y<Y_{th,i+1} for a certain priority.
   Partial Sensing with Adaptive Thresholds:

For resource selection on a set of slots of size Y, and one or more sensing occasions with sensing Y slots on each occasion, a UE may perform partial sensing with threshold adaptation.

Given a set of partial sensing values Y₁, Y₂, . . . , Yₙ, with Y₁<Y₂ . . . <Yₙ and corresponding a set of threshold values on the available ratio for resource selection, X₁, X₂, . . . , Xₙ, with X₁≥X₂≥ . . . ≥Xₙ, the transmitting UE starts partial sensing with Y₁ candidate slots. If the ratio of available resource over Y₁ slots is smaller than X₁% initially before increasing RSRP threshold, UE may change the partial sensing procedure using Y₂ candidate slots in the next round of partial sensing with new threshold X₂.

### Progressive Sensing:

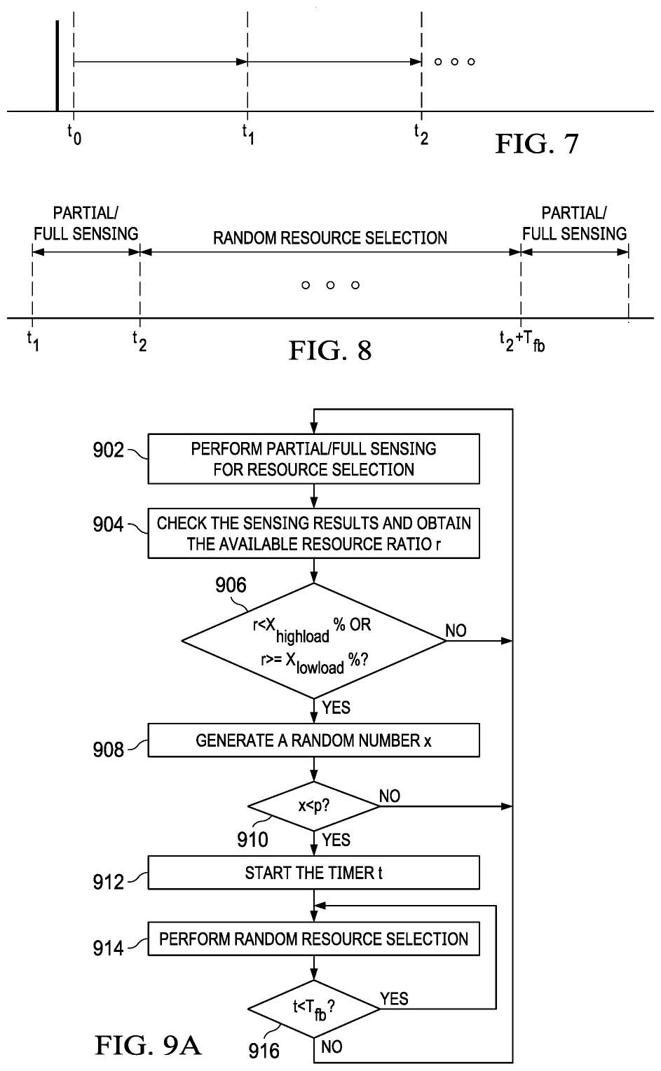

As shown in FIG. 7, when a packet arrives, the transmitting UE starts sensing at t₀, and performs sensing of t₁−t₀ slots. If the available resource ratio is smaller than corresponding threshold X₁% where X₁ is determined by t₁−t₀ and/or data priority, then the transmitting UE may continue partial sensing until t₂ instead of increasing the RSRP threshold. If the available resource ratio is smaller than X₂%, where X₂ is based on the sensing size until t₂, then continue the sensing until:
available resource ratio is greater than Xᵢ %, or
preconfigured threshold on the size of sensing slots is reached, or
the remaining slots in the resource selection window is below a threshold, or
the remaining packet delay budget is below a threshold.

The increment of sensing slots for progressive sensing can be the same.

### Random Resource Selection:

Random resource selection without monitoring the resources occupied by other UEs certainly can save a lot of power. To achieve large power savings, it is better to let the transmitting UE perform random resource selection in some conditions even when the transmitting UE is capable of partial/full sensing. One embodiment allows the transmitting UE switch between partial/full sensing and random resource selection, which can be viewed as a special case of the general concept presented before.

FIG. 8 illustrates a diagram of switching between sensing based and random resource selection. For sensing based resource selection, the reselection procedure attempts to select a certain number of sub-channels based on sensing evaluations. The system load can be indicated by the occupied resource ratio or available resource ratio, which can be obtained through full or partial sensing. When the load is high, meaning that the occupied resource ratio is large, e.g., close to 1, or available resource ratio is small, e.g., close to 0, a UE can switch to random resource selection. Those UEs do not rely on the results of sensing for a high load because the sensing thresholds would be increased a lot in order to find available resources. Based on this observation, one approach is to perform initial sensing to determine the system load from the sensing results. If the results indicate a high load, the benefits of sensing over random resource selection are limited. In such a case, the transmitting UE should perform random selection instead of partial sensing.

On the other hand, when the load is low, meaning that the occupied resource ratio is very small, i.e., close to 0, or available resource ratio is very large, i.e., close to 1, there are no or a very few resources occupied by other nearby UEs. The transmitting UE can then switch to random resource selection to reduce power consumption. Note that the transmitting UE must be able to monitor the PSCCH in order to make this determination. The condition can be set by a threshold on channel occupation ratio (CR) or available resource ratio, e.g., X_{highload} % and X_{lowload} %. In addition, a predefined timer T_{fb} can be specified and configured for the transmitting UE to fall back (revert) to partial/full sensing. For improved power savings, one embodiment is to switch back to partial sensing with a minimum number of slots configured, then gradually increase the number of slots based on sensing results. A randomness can be introduced so that probabilistic switching can be achieved. For example, generate a random number x uniformly distributed in [0,1], and compared it with a preconfigured value p∈[0,1]. If x<p, switch to random resource selection or not if x≥p.

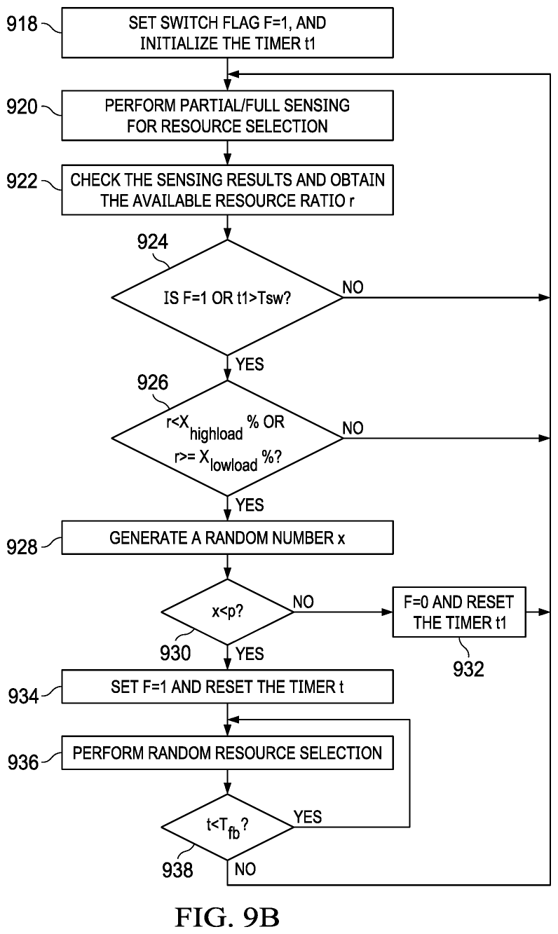

A flowchart for switching between sensing based resource selection and random resource selection is shown in FIG. 9A.

Moreover, the condition of the CR or available resource ratio indicating the high or low load of the system may hold for a while. However, a UE may perform the probabilistic switching after every sensing process, which eventually leads to switching in a very short time. To avoid this happening and keep the system stable, the UE can stay at the sensing state for a certain period once the probabilistic switch results in the back to the sensing instead of performing random resource selection. This can be achieved with a new timer Ts. A flowchart with this stability protection is shown in FIG. 9B.

Another condition is low power levels (e.g., battery levels). In such a case, when the battery is about draining out or below a certain level, to reduce power consumption, it is beneficial that this UE perform random resource selection instead of partial sensing/full sensing. Low power UEs may also be configured to perform random resource selection all the time and not to switch between partial/full sensing and random resource selection.

### Periodic Based Partial Sensing:

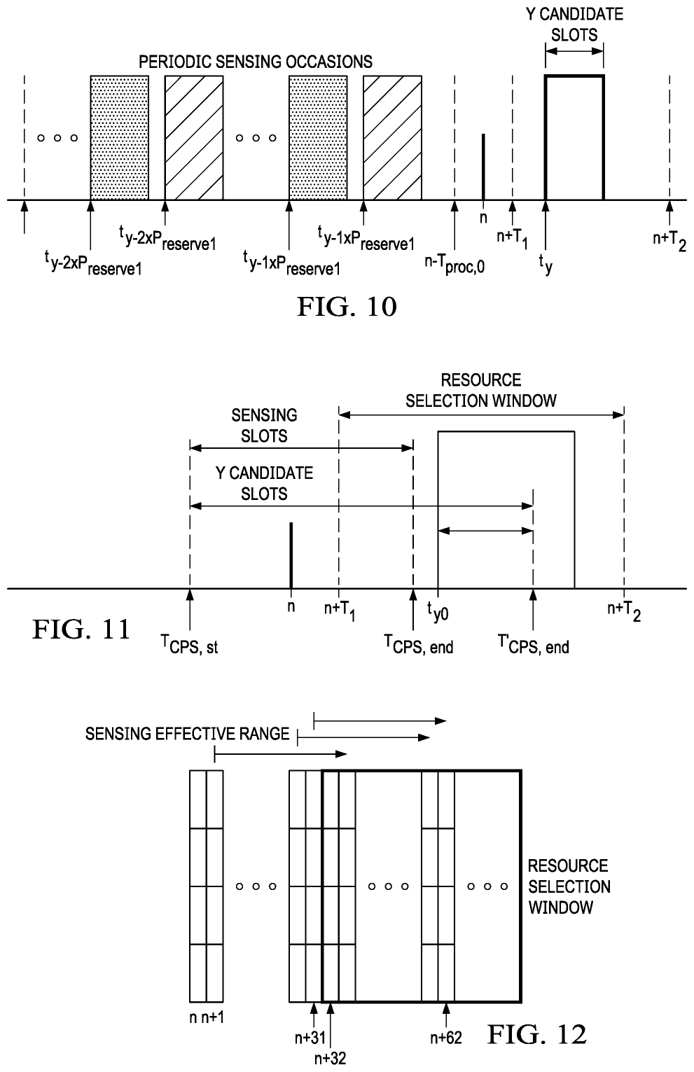

As shown in FIG. 10, when performing periodic based partial sensing, the transmitting UE monitors one or more periodic occasions with Y candidate slots on each occasion, where a periodic sensing occasion is a set of slots according to t_{y-k×P}_{ᵣₑₛₑᵣᵥₑ}^{SL}, t_{y}^{SL} is in the set of Y candidate slots within the resource selection window, and the set of k values indicate the sensing occasions. For example, when k∈{1, 2}, the UE performs partial sensing on t_{y-1×P}_{ᵣₑₛₑᵣᵥₑ}^{SL} and t_{y-2×P}_{ᵣₑₛₑᵣᵥₑ}^{SL}. If k is specified as a bitmap as in LTE V2X, i.e., {i₁, i₂, . . . , iₖ, . . . , }, iₖ∈{0,1}, the UE performs partial sensing on the occasion of t_{y-k×P}_{ᵣₑₛₑᵣᵥₑ}^{SL}, where iₖ=1. Since for some periodicity, the sensing occasion for a small k value may fall in the slots for UE processing time that is not used for sensing, to excluding the slots that is not used for sensing, the most recent sensing occasion is defined as, the values of k correspond to the most recent sensing occasion earlier than t_{y0}^{SL}−(T_{proc,0}^{SL}+T_{proc,1}^{SL}) for a given periodicity, Pᵣₑₛₑᵣᵥₑ. Then for a given periodicity, Pᵣₑₛₑᵣᵥₑ, the value of k corresponding to the last periodic sensing occasion prior to the most recent one is the second most recent sensing occasion. The value of k corresponding to the last periodic sensing occasion prior to the second most recent sensing occasion is the third most recent sensing occasion, and so on.

Based on sensing results, the transmitting UE forms a set of candidate resources on a set of Y slots in the resource selection window and selects one for sidelink transmission.

The transmitting UE may choose Y from a preconfigured range, where the minimum and maximum values of the range need to be configured. If the default maximum value corresponds to full sensing, then the maximum value is not needed. To have reliable sensing results, different values or minimum values for Y can be configured for different priorities. Due to discrete values of priorities, the procedure can then set a set of minimum values of Y corresponding to different priorities in the list.

However, setting different minimum values does not completely solve the issues for different priorities as the priority information for the new data may be obtained when resource selection is triggered at slot n. The sensing process t_{y-k×P}_{ᵣₑₛₑᵣᵥₑ}^{SL}<n may have a size of slots Y smaller than the minimum value of Y from the new data with a higher priority triggered at n. In this case, configuring a different minimum Y for different priority may not be meaningful. Also, for a high priority, setting one minimum value of Y to accommodate all possible traffic loads, heavy or low, may result in a large value on the minimum of Y which may be inefficient for power saving. It is then better to configure a small value of minimum Y, but the UE needs to adapt Y according to the sensing results, e.g., the available resource ratio threshold for partial sensing as described below.

Due to the shorter time for partial sensing, the sensing results may be unreliable, particularly for the available resource ratios. Also, due to supporting aperiodic transmissions in SL mode 2, with a small sensing window, it is highly probable there will be a resource collision particularly when the available resource ratio from partial sensing is small. For example, with 20% available resources from partial sensing, 80% are occupied indicating a high system load. With a shorter sensing time, the variance of the actual available resource ratio for 20% is much larger than for full sensing. Hence, the collision rate based on this sensing result could be much higher compared with full sensing. On the other hand, due to the smaller candidate pool for a small Y, for the same available resource ratio, e.g., 20%, the available candidate resources for partial sensing are much less than that for the full sensing. The collision rate can also be higher if another UE with new data reserves the resource in the same region. Then for partial sensing with a very small Y, a larger threshold than 20% on the available resource ratio should be used. Therefore, it is beneficial to specify a new list threshold X % or new rules for partial sensing.

Specifically, one embodiment reiterates some of rules in among 4 possible specifications of the threshold X % here. For periodic partial sensing, a relationship between Y and minimum value of X, i.e., X (Y), can be specified. It can be a function of Y and data priority, i.e., X(prio_{TX}, Y). Moreover, it can be specified with the range of Y for a threshold Xᵢ %, Y_{th,i}≤Y<Y_{th,i+1} for a certain priority.

One alternative approach can simply restrict from the lowest value of X from the existing table sl-TxPercentageList specified in R16 when Y<Yth(Xₘᵢₙ) where Xₘᵢₙ is selected based on data priority, and use the next X on the list.

For better power savings, UE may start with Y from a configured minimum value. If the available resource ratio X′ from the sensing results is smaller than configured X (prio_{TX}, Y) for the smallest Y, then the UE increases Y to the next value in the list or determine next Y1, based on sensing results and perform partial sensing in the next round of sensing.

For periodic sensing occasions, since R16 mode 2 supports SL transmissions with different periodicities and aperiodic transmissions, it is better to provide a certain flexibility to partial sensing. The value k can be configured with a bitmap. To achieve better power saving performance, a maximum number of 1's in the bitmap can be specified, i.e., at most kₘₐₓ 1's in the bitmap of k can be configured, which is maximum number of sensing occasions. For example, the bitmap of k is denoted as {i₁, i₂, . . . , iₖ, . . . , i₁₀}, with kₘₐₓ=5, the sum of the number of 1's is Σ₋(k=1)\hat{ } [symbol] i_k≤k_max_maxum number of sensing occasions, or kₘₐₓ occasions.

### Contiguous Based Partial Sensing:

Aperiodic transmission is supported for sidelink transmissions. For sidelink resource allocation, it is desirable for a UE to detect possible aperiodic traffic from other UEs to avoid resource conflicts. For this purpose, a UE performs contiguous based partial sensing for resource (re)selection. Contiguous based partial sensing can be specified for resource allocation for both periodic traffic and aperiodic traffic for the sensing UE.

List of notations may include:
T_{CPS,st}: the first slot in the sensing window (general definition),
T_{CPS,end}: the last slot in the sensing window (general definition), or sensing window with minimum window size,
T′_{CPS,end}: an alternative last slot in the sensing window (general definition), or sensing window with maximum window size,
n+T_{A}: the first slot of the sensing window which is related to the slot n where resource (re)selection is triggered,
n+T_{B}: the last slot of the sensing window which is related to the slot n where resource (re)selection is triggered,
t_{y0}: the first slot of the set of candidate slots in the resource selection window of size Y in periodic based partial sensing.

### Contiguous Based Partial Sensing for Periodic Traffic:

For a sensing UE with periodic traffic, as shown in FIG. 10, when resource (re)selection is triggered at slot n, the UE will select a resource from a set of Y candidate slots within a resource selection window [n+T₁, n+T₂]. The starting slot of the Y candidate slots is at slot t_{y0}. If a UE performs contiguous based partial sensing, it monitors the slots between [T_{CPS,st}, T_{CPS,end}], with a problem of how to select T_{CPS,st} and T_{CPS,end}.

For aperiodic traffic, the UE selects multiple candidate resources, but with the restriction that the gap between two consecutive candidate resources is smaller than 32 slots. For example, when a resource is selected on slot m₁, meaning that the other candidate resource is located in the range of slots [m₁−31, m₁+31]. Therefore, to select resources in the set of Y candidate slots, it is unnecessary to monitor the slot t_{y}−32 or before. Then, the starting point of contiguous partial sensing is at T_{CPS,st}=t_{y0}−31. Since for periodic traffic, n is known in advance, it is fine that t_{y0}−31<n. Given the time to complete the sensing process and resource selection processing, the ending slot for contiguous partial sensing is T_{CPS,end}=t_{y0}−T_{proc,0}−T_{proc,1}. Contiguous partial sensing is similar to re-evaluation process. To provide better resource selection, one approach can limit the total processing time to T_{proc,1}. Then, T_{CPS,end}=t_{y0}−T_{proc,1}. The sensing window for contiguous partial sensing is [t_{y0}−31, t_{y0}−T_{proc,1}]. If the sensing window is specified by the notation [n+T_{A}, n+T_{B}], then T_{A}=−n+t_{y0}−31 and T_{B}=−n+t_{y0}−T_{proc,1}.

As aforementioned, based on the sensing results, monitoring a slot can only determine resource occupancy or reservation from aperiodic traffic within 32 slots. For example, as shown in FIG. 12, monitoring slot n+1 will detect the resource occupancy from n+1 to n+32, and monitoring slot n+2 will detect the resource occupancy from n+2 to n+33, and so on. Then monitoring slot n+31 will detect the resource occupancy from n+31 to n+62. If the resource selection window starts with n+32, sensing on slot n+1 has the effective sensing result on only one slot, i.e., slot n+32, in the resource selection region. Although it may improve the sensing reliability on slot n+32, it has much less impact on the resource selection region. Similarly, for the several beginning slots in the sensing window, these sensing slots close to the resource selection starting slot have a large coverage on the resource selection region, e.g., sensing on slot n+31 is able to provide resource occupancy on slots [n+32, n+62] in the resource selection window; and sensing on slot n+30 is able to provide resource occupancy on slots [n+32, n+61] in the resource selection window, and so on. Therefore, to achieve more efficiency on sensing and power savings, it is better to reduce the sensing window size. For contiguous partial sensing for periodic traffic, sensing window can start later than T_{CPS,st}=t_{y0}−31, which is 31 slots earlier than the first slot of the Y candidate resource region. For flexibility, T_{CPS,st} can be configured by higher layers with default setting as t_{y0}−31. A list of T_{CPS,st} or T_{A} can then be specified, e.g. T_{CPS,st}=t_{y0}−a×32+1, a=1, ½, ¼ . . . . Such flexible design with shorter sensing time may be applicable to inter-UE coordination where the timing for the entire coordination procedure is stringent, particularly, for aperiodic traffic.

It is possible that there is an overlap between the slots for contiguous partial sensing and the slots in periodic based partial sensing. Based on the sensing results from contiguous partial sensing and periodic partial sensing if available, UE selects the resource from the set of Y candidate slots within the resource selection window. After selecting the resource, the UE then performs re-evaluation and pre-emption if configured.

The sensing results may be unreliable due to the short sensing window size. On the other hand, the value of Y can be larger than 32. Contiguous partial sensing does not provide any benefit for resource selection on slots [t_{y0}−T_{proc,1}+32, t_{y0}+Y−1]. Also, if the sensing UE detects a large amount of aperiodic traffic within the sensing window [t_{y0}−31, t_{y0}−T_{proc,1}] resulting in many resources being occupied on [t_{y0}, t_{y0}−T_{proc,1}+31], relying on periodic sensing results for resource allocation on [t_{y0}−T_{proc,1}+32, t_{y0}+Y−1] will cause many resource conflicts. Therefore, a larger threshold on the available resource ratio X % is desirable than used for full sensing for data with the same priority. Continuing contiguous partial sensing will be also beneficial if the number of available resources on [t_{y0}, t_{y0}−T_{proc,1}+31] is small. However, different from re-evaluation process where the transmission resource is allocated, e.g., on slot m, here the UE does not have that information in advance. Setting the sensing slot based on m is not appropriate. Although it is possible to report available candidate resource set S_{A} to the MAC layer on some slot and getting a grant on slot m, this two-stage process may functionally overlap with the re-evaluation process. Since the purposes of initial sensing and re-evaluation are different, with one for resource allocation and the other for checking resource conflict, it is better to separate them. Therefore, a UE can continue sensing till T′_{CPS,end}. Although the UE can continue sensing until slot T′_{CPS,end}=t_{y0}+Y−1−T_{proc,1}, which may only leave maximum 1 slot for resource select, it is better to set an offset, i.e., T′_{CPS,end}=max(t_{y0}−T_{proc,1},t_{y0}+Y−1−T_{proc,1}−T′_{CPS,offset}). T′_{CPS, offset}, can be set or fixed to 31. A UE can report the available resource any time after slot t_{y0}−T_{proc,1} to the MAC layer.

Based on above descriptions, one embodiment proposes to set minimum and maximum values related to sensing boundary, i.e., T_{CPS,end} and T′_{CPS,end}, for contiguous partial sensing for the transmission with periodic traffic. A UE reports available resource set any time in between. If specifying the sensing window notation as [n+T_{A}, n+T_{B}], then T_{B} or T_{B,min}=−n+T_{CPS,end} and T_{B,max}=−n+T′_{CPS,end} with the values of T_{CPS,end} and T′_{CPS,end} provided above. After a resource is selected, it is up to UE or based on configuration to perform the re-evaluation or pre-emption.

### Contiguous Based Partial Sensing for Aperiodic Traffic:

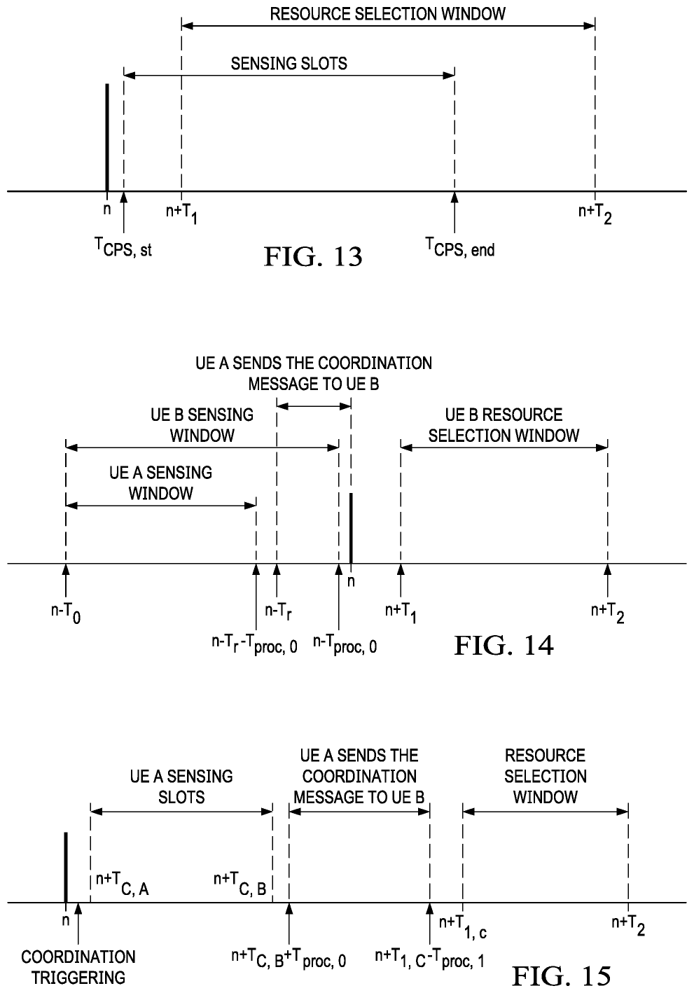

For UE with aperiodic traffic, a data packet could arrive at any time without any prior knowledge. Therefore, it is impossible for a UE to know in advance when resource selection is triggered at slot n. Thus, contiguous based partial sensing for aperiodic traffic can only start after n, i.e., T_{CPS,st}>n, as shown in FIG. 13. The earliest possible starting point is T_{CPS,st}=n+1. i.e., T_{A}=1. Naturally, one option to define sensing window size for detecting the resource occupancy from aperiodic traffic is 32 subtracting the processing times to complete sensing and resource reservation, i.e., T_{CPS,end}=n+31−T_{proc,0}−T_{proc,1}. Similarly as before, it may be enough to complete both sensing and resource selection processes within T_{proc,1}. Then T_{CPS,end}=n+31−T_{proc,1}. In the sequel, only T_{proc,1} is used for processing time of two processes. If the two are separated, T_{proc,1} can be replaced with T_{proc,0}+T_{proc,1}.

When UE performs contiguous partial sensing and resource (re-)selection is triggered in slot n, to achieve maximum power savings, the UE may perform partial sensing with a minimum window size to have reliable sensing results for resource selection. The sensing results for aperiodic traffic from other UEs are only beneficial for the resource selection on the slots [T_{CPS,end}+T_{proc,1}, T_{CPS,end}+31]. For the resources on slots [T_{CPS,end}+31, n+T₂], it is equivalent to random resource selection if no other sensing results are available. On the other hand, the sensing window size T_{CPS,end}−T_{CPS,st}+1 may also impact the reliability of reported candidate resources on [T_{CPS,end}+T_{proc,1}, T_{CPS,end}+31].

The available resource ratio on [T_{CPS,end}+T_{proc,1}, T_{CPS,end}+31] derived from contiguous partial sensing is an important factor for resource selection. If the ratio is small, the available resources ratio on slots [T_{CPS,end}+32, n+T₂] may also be small. Assuming they are all available, reporting them in SA will lead to a high conflict rate. To solve this issue, first it is beneficial to specify a larger threshold on the available resource ratio X %. Second, if the available resource ratio is not large enough, the UE continues sensing instead of increasing the RSRP threshold. The UE stops sensing when the available resource sis enough for resource selection. The sensing window can be increased in a predefined value.

Also, since the value of T₂ is left to UE implementation, it is difficult to specify a maximum slot for the UE performing contiguous partial sensing. In this case, one embodiment can specify the minimum sensing window to achieve better power savings. Based on the illustration in FIG. 11 and corresponding discussions, for efficient sensing and power consumption, it is better to reduce the sensing window size and, in this case, start the resource selection window earlier. Another advantage for having a smaller sensing window for aperiodic traffic is to have low latency, which is one of key features for dynamic transmission in sidelink. Then, the minimum sensing end slot can be specified with one of following.

The minimum window size is non-configurable, fix a value smaller than 31−T_{proc,1}. i.e., T_{B}<31−T_{proc,1}

The minimum window size is configurable such as

A range of minimum window size is specified, with the maximum being 31−T_{proc,1}, e.g., 31−T_{B,min}≤T_{B}≤31−T_{proc,1}.

A set of predefined minimum window size with maximum window size being 31−T_{proc,1}, e.g., besides [n+1, n+31−T_{proc,1}], add [n+1, n+a*32] where a is configurable from ½, ¼, . . . i.e., T_{B}=a*32 or 31−T_{proc,1}

The resource selection window is in the slot [n+T_{B}+T_{proc,1}, n+T₂]. After that it is up to UE whether to continue the contiguous partial sensing and report the available resource on n′ for the resources on [n′+T_{proc,1}, n+T₂]. Since T₂ is bounded by PDB, the contiguous sensing window is then also restricted by the remaining PDB. Then the sensing window shall end at n+min(T_{B}, PDB−T_{proc,1}).

It is worth noting that although each scheme is described under a scenario or in a section in this document, the scheme can be applied to any other scenarios whenever is applicable.

### Sensing and Report Procedures for Inter-UE Coordination:

In inter-UE coordination for sidelink communications, one UE, e.g., UE A, provides certain coordination information to assist another UE, e.g., UE B, for resource selection, where the coordination information can be a set of resources. From 3GPP RAN1 discussions, three types of resources for inter-UE coordination are defined, namely, type A preferred resources, type B not-preferred resources, and type C resources with conflicts. The determination of these three types of resources can be obtained from the sensing process at UE A. Therefore, if sensing is needed, the sensing process on UE A is tied to UE B's resource selection, which needs to be specified. Besides the sensing process at UE A, information exchange between UE B and UE A needs to be determined.

For periodic traffic at UE B, once coordination is triggered, the transmission slot and periodicity can be forwarded from UE B to the UE A in a message, e.g., in the triggering message if inter-UE coordination is triggered by UE B explicitly. The effective coordination time during which UE A needs to provide coordination information to UE B can also be included in the message. UE A can then perform sensing and resource selection procedure similar to that of UE B without coordination. However, for inter-UE coordination, the timing for UE A sensing and processing are different from the sensing process at a UE without coordination as UE A needs to send the coordination information to UE B in time for UE B to reserve the resources in the resource selection window.

As illustrated in FIG. 14, when the periodic traffic is triggered at slot n for UE B, UE B's resource selection window is on [n+T₁, n+T₂]. Without inter-UE coordination, based on NR Rel-16 specification, the sensing window for UE B is on slots [n−T₀, n−T_{proc,0}] and T₂ is up-to UE B's implementation. With coordination, in order to form any type of resource set within the resource selection region at UE A, the resource selection window has to be known at UE A. Then UE A needs to know resource selection periodicity at UE B, e.g., the resource selection triggering slot n. UE A also needs to know periodic T₂ for resource selection, which can be included in the triggering message. Since sensing is now performed at UE A, additional time for UE A sending a coordination message to UE B is needed. Therefore, the timing requirement for UE A's sensing process is different from that for the sensing process at UE B. For example, as shown in FIG. 14, UE A monitors the slots [n−T₀, n−Tᵣ−T_{proc,0}], where Tᵣ is the time requirement for UE A to send the coordination message to UE B. The coordination report window is then [n−Tᵣ, n] which may include the processing time for UE A transmitting the message. If partial sensing is configured by the higher layer for power saving or by UE B through the coordination triggering message, the sensing process at UE A for periodic traffic at UE B can be easily extended with the periodic based partial sensing.

The aforementioned sensing is mainly for detecting the periodic traffic from other UEs. It is also important to detect aperiodic traffic, e.g., with contiguous based partial sensing for detecting aperiodic traffic. Since the SCI can only inform resource reservations within a window of 32 slots, the entire UE coordination procedure for one transmission should be done within 32 slots in order to have benefit from the coordination. On the other hand, sensing reliability depends on the sensing window size.

For aperiodic traffic at UE B, as shown in FIG. 15, the packet arrives at slot n. The coordination is then triggered at n′>n. The earliest time is on slot n+1. After UE A receives the trigger message, UE A starts sensing on slots [n+T_{C,A}, n+T_{C,B}], then reporting one or more coordination messages to UE B within slots [n+T_{C,B}+T_{proc,0}, n+T_{1,C}−T_{proc,1}] where T_{1,C} is the first slot in the resource selection window. Again, the coordination procedure needs to be completed within 32 slots. To have more benefit from inter-UE coordination, sensing and reporting procedures need to be completed soon enough to ensure a certain size of resource selection window for UE B. Therefore, the proposal of configuring a short sensing window, e.g., monitoring slots [n+1, n+a*32] where a is configurable from ½, ¼, etc., can be used here for inter-UE coordination.

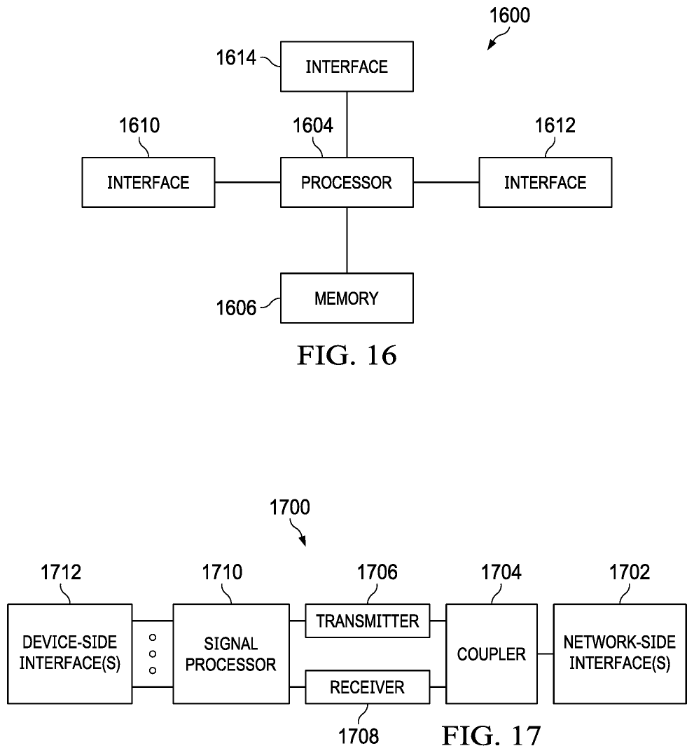

FIG. 16 illustrates a block diagram of an embodiment processing system 1600 for performing methods described herein, which may be installed in a host device. As shown, the processing system 1600 includes a processor 1604, a memory 1606, and interfaces 1610-1614, which may (or may not) be arranged as shown in FIG. 16. The processor 1604 may be any component or collection of components adapted to perform computations and/or other processing related tasks, and the memory 1606 may be any component or collection of components adapted to store programming and/or instructions for execution by the processor 1604. In an embodiment, the memory 1606 includes a non-transitory computer readable medium. The interfaces 1610, 1612, 1614 may be any component or collection of components that allow the processing system 1600 to communicate with other devices/components and/or a user. For example, one or more of the interfaces 1610, 1612, 1614 may be adapted to communicate data, control, or management messages from the processor 1604 to applications installed on the host device and/or a remote device. As another example, one or more of the interfaces 1610, 1612, 1614 may be adapted to allow a user or user device (e.g., personal computer (PC), etc.) to interact/communicate with the processing system 1600. The processing system 1600 may include additional components not depicted in FIG. 16, such as long term storage (e.g., non-volatile memory, etc.).

In some embodiments, the processing system 1600 is included in a network device that is accessing, or part otherwise of, a telecommunications network. In one example, the processing system 1600 is in a network-side device in a wireless or wireline telecommunications network, such as a base station, a relay station, a scheduler, a controller, a gateway, a router, an applications server, or any other device in the telecommunications network. In other embodiments, the processing system 1600 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1610, 1612, 1614 connects the processing system 1600 to a transceiver adapted to transmit and receive signaling over the telecommunications network. FIG. 17 illustrates a block diagram of a transceiver 1700 adapted to transmit and receive signaling over a telecommunications network. The transceiver 1700 may be installed in a host device. As shown, the transceiver 1700 comprises a network-side interface 1702, a coupler 1704, a transmitter 1706, a receiver 1708, a signal processor 1710, and a device-side interface 1712. The network-side interface 1702 may include any component or collection of components adapted to transmit or receive signaling over a wireless or wireline telecommunications network. The coupler 1704 may include any component or collection of components adapted to facilitate bi-directional communication over the network-side interface 1702. The transmitter 1706 may include any component or collection of components (e.g., up-converter, power amplifier, etc.) adapted to convert a baseband signal into a modulated carrier signal suitable for transmission over the network-side interface 1702. The receiver 1708 may include any component or collection of components (e.g., down-converter, low noise amplifier, etc.) adapted to convert a carrier signal received over the network-side interface 1702 into a baseband signal. The signal processor 1710 may include any component or collection of components adapted to convert a baseband signal into a data signal suitable for communication over the device-side interface(s) 1712, or vice-versa. The device-side interface(s) 1712 may include any component or collection of components adapted to communicate data-signals between the signal processor 1710 and components within the host device (e.g., the processing system 1600, local area network (LAN) ports, etc.).

The transceiver 1700 may transmit and receive signaling over any type of communications medium. In some embodiments, the transceiver 1700 transmits and receives signaling over a wireless medium. For example, the transceiver 1700 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1702 comprises one or more antenna/radiating elements. For example, the network-side interface 1702 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1700 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
determining, by a user equipment (UE), a candidate resource region for transmission of data, the candidate resource region indicating candidate resource slots for the transmission of the data;
monitoring, by the UE, sensing slots within a slot window to determine available resources from the candidate resource region, wherein a first slot of the sensing slots is determined in accordance with a first slot of the candidate resource slots;
selecting, by the UE, a resource from the available resources; and
transmitting, by the UE, the data over the resource selected from the available resources.

2. The method of claim 1, wherein the transmission of the data is a periodic transmission.

3. The method of claim 1, wherein the first slot of the sensing slots is determined in accordance with a default number of slots.

4. The method of claim 3, wherein the default number of slots is 31.

5. The method of claim 3, wherein the first slot of the sensing slots is further determined in accordance with a preconfigured number of slots, the preconfigured number of slots being smaller than the default number of slots.

6. The method of claim 3, wherein the first slot of the sensing slots is earlier than the first slot of the candidate resource region by the default number of slots.

7. The method of claim 5, wherein the first slot of the sensing slots is earlier than the first slot of the candidate resource slots by the preconfigured number of slots.

8. The method of claim 1, wherein the transmission of the data is an aperiodic transmission.

9. The method of claim 1, wherein the first slot of the sensing slots is further determined in accordance with a minimum number of sensing slots, the minimum number of sensing slots being a default value.

10. The method of claim 9, wherein the first slot of the sensing slots is earlier than the first slot of the candidate resource slots by at least the minimum number of sensing slots.

11. The method of claim 9, wherein the default value is 31.

12. The method of claim 1, wherein the first slot of the sensing slots is earlier than the first slot of the candidate resource slots by at least a minimum number of sensing slots, the minimum number of sensing slots being a preconfigured value from a range of values.

13. A user equipment (UE) comprising:
a non-transitory memory storage comprising instructions; and
one or more processors in communication with the non-transitory memory storage, the one or more processors executing the instructions to cause the UE to perform operations including:
determining a candidate resource region for transmission of data, the candidate resource region indicating candidate resource slots for the transmission of the data;
monitoring sensing slots within a slot window to determine available resources from the candidate resource region, wherein a first slot of the sensing slots is determined in accordance with a first slot of the candidate resource slots;
selecting a resource from the available resources; and
transmitting the data over the resource selected from the available resources.

14. The UE of claim 13, wherein the transmission of the data is a periodic transmission.

15. The UE of claim 13, wherein the first slot of the sensing slots is further determined in accordance with a default number of slots.

16. The UE of claim 15, wherein the default number of slots is 31.

17. The UE of claim 15, wherein the first slot of the sensing slots is further determined in accordance with a preconfigured number of slots, the preconfigured number of slots being smaller than the default number of slots.

18. The UE of claim 15, wherein the first slot of the sensing slots is earlier than the first slot of the candidate resource region by the default number of slots.

19. The UE of claim 17, wherein the first slot of the sensing slots is earlier than the first slot of the candidate resource slots by the preconfigured number of slots.

20. A method comprising:
monitoring, by a first user equipment (UE), sensing slots having a first sensing window size for a first candidate resource region, the first candidate resource region comprising candidate resources for transmission of data by a second UE;
determining, by the first UE, a set of preferred resources or non-preferred resources in the first candidate resource region for the transmission of the data by the second UE;
selecting, by the first UE, a resource from a second candidate resource region having a second sensing window size, the second candidate resource region containing second candidate resources for transmission of the set of preferred resources or non-preferred resources to the second UE, wherein a last slot of the second candidate resource region is determined in accordance with the first candidate resource region; and
transmitting, by the first UE to the second UE, the set of preferred resources or non-preferred resources for the transmission of the second UE over the resource.
